(19) United States
(12) Patent Application Publication
(10) Pub. No.: US 2015/0026272 A1
(43) Pub. Date: Jan. 22, 2015

(54) SERVER DEVICE, METHOD, AND NON-TRANSITORY COMPUTER-READABLE STORAGE MEDIUM STORING PROGRAM

(71) Applicant: DeNA Co., Ltd., Tokyo (JP)

(72) Inventor: Ichito NAGATA, Tokyo (JP)

(21) Appl. No.: 14/299,993

(22) Filed: Jun. 9, 2014

(30) Foreign Application Priority Data
Jul. 18, 2013 (JP) 2013-149962

(51) Int. Cl. H04L 12/58

(52) U.S. Cl. CPC H04L 51/046
USPC 709/206

(57) ABSTRACT

The present invention provides a server device that receives a start request of a predetermined social networking service (SNS) from a terminal of a user, and information about one or more participation users that are to participate in the SNS, and manages each participation user's turn to upload an image. The server device notifies a terminal of a turn-come user whose turn has come of a fact that the turn-come user's turn has come, and sets a participation user whose turn is next as a new turn-come user when receiving the image uploaded by the turn-come user.

### BACKGROUND OF THE INVENTION

1. Field of the Invention

The present invention relates to a social communication technology using an information communication terminal.

2. Description of Related Art

A service called a chat has been provided so far. The service is for a text communication in real time using an information processing device such as a personal computer (PC) terminal or a mobile terminal. Exemplary modes of the chat service include a chat between the users on a one-to-one basis, a chat in a group for a plurality of users in a specific group, and a chat between groups. Such a chat is held among the users that have entered a virtual room referred to as a chat room.

Meanwhile, multifunctional mobile terminals referred to as a smartphone have rapidly spread since 2010. Thus, many social networking services (SNS) including a chat service on the assumption of the use on a mobile terminal are provided and the number of the users increases.

Under the circumstance, SNS services in which the user can share the photograph that the user has taken with the friend by posting the photograph through a network are provided (for example, see JP 2013-516002 W and JP 2013-016156 A).

### SUMMARY OF THE INVENTION

However, the user often has a negative attitude to a photograph posting in the existing SNS services. For example, the users sometimes exert self-control depending on the person or contents in the photograph and hesitate to post a photograph. This makes it difficult to stimulate the communication among the users with the photograph posting.

In light of the foregoing, an objective of the present invention is to provide a server device, a method, and a non-transitory computer-readable storage medium storing program that are capable of enhancing the photograph posting among the participation users of an SNS.

An aspect of the present invention is a server device. The server device includes: a service information reception unit configured to receive a start request of a predetermined SNS from a terminal of a user, and information about one or more participation users that are to participate in the SNS through a communication line; a turn management unit configured to manage each participation user's turn to upload an image; a notification unit configured to notify a terminal of a turn-come user whose turn managed with the turn management unit has come of a fact that the turn-come user's turn has come after the service information reception unit has received the start request; an image reception unit configured to receive an image uploaded from a terminal of a participation user and store the image in a memory; and a display control unit configured to display the image received with the image reception unit on a screen of the terminal of the participation user. The turn management unit sets a participation user whose turn is next as a new turn-come user when the image reception unit has received the image uploaded by the turn-come user.

According to the aspect, notifying the terminal of the turn-come user whose turn has come of the fact that the turn-come user's turn has come mildly forces the participation users to post a photograph in turns. This can add a playful touch to the photograph posting and can provide an environment in which the use can easily post a photograph. This can enhance the photograph posting from the participation users.

The display control unit can display a reminder button for reminding a turn-come user to upload an image on a terminal of a participation user other than the turn-come user. The notification unit can notify the terminal of the turn-come user of reception of a reminder request when receiving the reminder request from the participation user whose terminal displays a reminder button.

According to the aspect, the notification unit notifies the terminal of the turn-come user of the reception of a reminder request when receiving the reminder request from the participation user whose terminal displays a reminder button. This can enhance the photograph posting from the participation users.

The server device can further include a search process unit configured to perform a search process for an image after receiving a search word from the participation user. The display control unit can display one or more images retrieved in the search with the search process unit on the terminal of the participation user, and the image reception unit can receive a retrieved image that the participation user has selected from among the retrieved images.

According to the aspect, the display control unit can display one or more images retrieved in the search with the search process unit on the terminal of the participation user and the image reception unit receive a retrieved image that the participation user has selected from among the retrieved images. This can facilitate the acquisition of a photograph to be posted and the posting of the photograph. This can enhance the photograph posting from the participation users.

Another aspect of the present invention is a method. The method includes: receiving a start request of a predetermined social networking service (SNS) from a terminal of a user, and information about one or more participation users that are to participate in the SNS through a communication line; notifying, after receiving the start request, a terminal of a turn-come user whose turn to upload an image has come of a fact that the turn-come user's turn has come, the turn being set for each participation user; receiving an image uploaded from a terminal of a participation user and storing the image in a memory; displaying the image received from the participation user on a screen of the terminal of the participation user; and setting a participation user whose turn is next as a new turn-come user after reception of the image uploaded by the turn-come user.

Another aspect of the present invention is a non-transitory computer-readable storage medium storing program for causing a computer to execute a process. The process can include: receiving a start request of a predetermined social networking service (SNS) from a terminal of a user, and information about one or more participation users that are to participate in the SNS through a communication line; notifying, after receiving the start request, a terminal of a turn-come user whose turn to upload an image has come of a fact that the turn-come user's turn has come, the turn being set for each participation user; receiving an image uploaded from a terminal of a participation user and storing the image in a memory; displaying the image received from the participation user on a screen of the terminal of the participation user; and setting a participation user whose turn is next as a new turn-come user after reception of the image uploaded by the turn-come user.

Note that arbitrary combinations of the above-mentioned components, or variations obtained by converting the expressions such as the methods, devices, systems, and computer programs in the present invention into each other can be applied as an aspect of the present invention.

### Advantageous Effect of the Invention

The present invention can enhance the photograph posting from the participation users in an SNS.

### BRIEF DESCRIPTION OF THE DRAWINGS

FIG. 1 is a diagram illustrating an SNS system according to a first embodiment of the present invention;

FIG. 2 is a diagram illustrating an exemplary configuration of a server device in FIG. 1;

FIG. 3 is a diagram illustrating an exemplary configuration of a mobile terminal or a PC terminal in FIG. 1;

FIG. 4 is a diagram illustrating a first exemplary screen display on the user terminal in FIG. 1;

FIG. 5 is a diagram illustrating a second exemplary screen display on the user terminal in FIG. 1;

FIG. 6 is a diagram illustrating a third exemplary screen display on the user terminal in FIG. 1;

FIG. 7 is a diagram illustrating a fourth exemplary screen display on the user terminal in FIG. 1;

FIG. 8 is a diagram illustrating a fifth exemplary screen display on the user terminal in FIG. 1; and

FIG. 9 is a flowchart illustrating an exemplary process in the server device in FIG. 1.

### DETAILED DESCRIPTION OF THE INVENTION

The summary of the present invention will be described before the description of the embodiments of the present invention. The present invention relates to a technique for providing a photograph posting environment to the participation users in an SNS system that is conducted by a plurality of the users in the SNS system through a network.

When posting a photograph in an existing SNS system, the user sometimes exerts self-control due to invasion of privacy or a sense of shame depending on the person or contents in photograph. Thus, the user sometimes hesitates to post such a photograph. This often reduces the number of photograph postings. Even when a user posts a photograph, the photograph often shows an ordinary scene such as what the user has eaten. Thus, the communication with photographs is not often stimulated.

According to the present embodiment, a turn system is introduced to the photograph posting such that the participation users basically post photographs in turns. After a user whose turn has come (hereinafter, referred to as a turn-come user) has posted a photograph to an SNS, it is the next user's turn (the next user is a partner user when two users participate, and is the user next to the turn-come user when three or more users participate). However, the user whose turn has not come can also post a photograph. In such case, it is the same user's turn, and it is not the turn of the user who has posted the photograph.

Once the user whose turn has come has started the application, a first screen after the start becomes an image posting screen. The image posting screen can be a screen for taking an image with a camera or a screen for selecting an image. In other words, once the user whose turn has come has started the application, a screen for directly posting an image is displayed on the screen. This enables the user to easily post an image without a complicated operation. As described above, introducing a turn system to the image posting can make the user aware of the fact that it is the user's turn to post an image. This enhances the photograph posting by user and thus can stimulate the exchange of images between the users.

The present invention solves the problem as described above. Alternate photograph posting in the turn system creates an environment in which the users post photographs like playing a game without a time to hesitate to post a photograph. Such an aspect increases the number of photograph postings and thus can stimulate the communication.

### First Embodiment

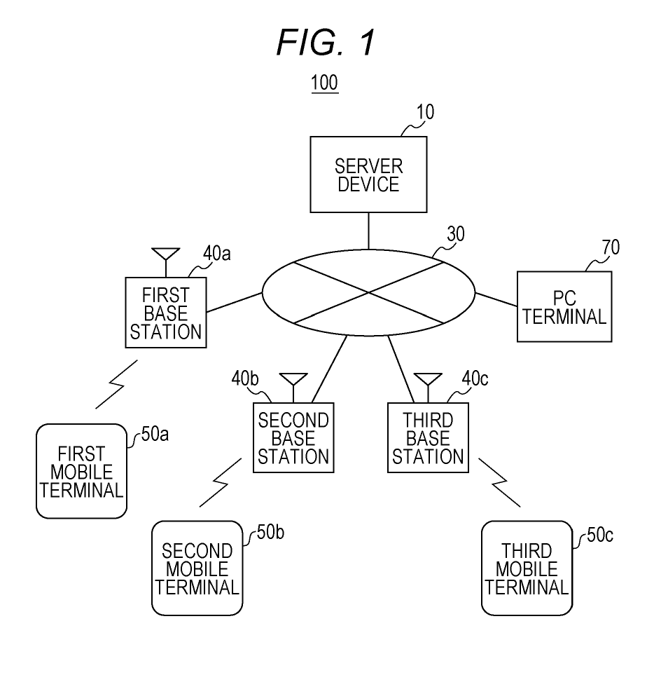

First, a first embodiment will be described. FIG. 1 illustrates an SNS system 100 for providing the photograph posting service according to the first embodiment of the present invention. The photograph posting service in the SNS system 100 is a closed communication service aimed at getting the users to alternately post photographs and can be provided as a native application.

The SNS system 100 includes a server device 10 and a network 30 connecting the server device 10 to a base station 40 through a wired line, a base stations 40 representative of a first base station 40a to a third base station 40c, a mobile terminal 50 representative of a first mobile terminal 50a to a third mobile terminal 50c, and a PC terminal 70.

Note that, although only three base stations 40 and mobile terminals 50 are illustrated for convenience of the drawing, the numbers are not limited to the drawing. More base stations 40 and mobile terminals 50 can exist. The same can be said for the PC terminal 70. The drawing illustrates that the first mobile terminal 50a to the third mobile terminal 50c are connected to different base stations 40, respectively. However, the configuration is not limited to the drawing. It should be understood that a plurality of mobile terminals 50 that is connected to a base station 40 can also be applied to the present invention.

The server device 10 is for implementing and providing the photograph posting service or the chat service. The server device 10 performs a communication process required to provide the services with the mobile terminal 50 or the PC terminal 70 through the network 30 and the base station 40.

Note that the description of the fact that the communication process is performed through the network 30 and the base station 40 is omitted hereinafter, for example, merely using the expression “the communication process is performed between the server device 10 and the mobile terminal 50 or the PC terminal 70” for sake of simplicity. Furthermore, the mobile terminal 50 and the PC terminal 70 will sometimes collectively be referred to as a user terminal hereinafter. The server device 10 can be a platform that provides the network service, or can be a server that provides the application for the network service.

Although the server device 10 will hereinafter be described as a subject to control for performing the photograph posting service, the present invention is not limited to the description. The server device 10 can share the function with other devices such as the user terminals to cooperate with each other in order to implement the preset invention.

The server device 10 causes the user terminal to download the application according to the request from the user terminal. Alternatively, the application can be downloaded from an application providing server other than the server device 10 to the user terminal. After that, the user can start using the photograph posting service by uploading the contact information stored in the memory in the user terminal and importing the information to the memory in the server device 10.

In that case, the server device 10 includes a room generation function for generating a new room for performing the photograph posting service, a photograph posting function for performing the photograph posting service in the generated room, a turn control function for controlling the order of the photograph posting, a friend suggestion function for suggesting a friend in the SNS system 100, a friend list management function for managing the list of friends, a search function for retrieving a friend or retrieving a partner to share an image, and a mail integration function for having a chat with a user that has not been registered in the SNS.

The room generation function includes a function for generating a room for using the photograph posting service, and a function for selecting a user to be invited to the generated room. To generate a room, the room generation function receives the name of the room and the theme required for the photograph to be posted from the user terminal. To select a participation user, the room generation function notifies the user selected by the user of a participation request in order to register the user that has sent a response that the user is to participate as a participation user.

The photograph posting function includes a function for receiving the photograph posted by the participation user in the room to display the photograph on the screen in the terminal of the participation user. The photograph posting function receives the comment or evaluation on the posted photograph to similarly display them on the screen in the terminal of the participation user.

The turn control function is a function for controlling the turn of the photograph posting. The turn control function notifies the terminal of the participation user whose turn has come of the fact that the turn has come to encourage the user to post a photograph. When the turn-come user has posted a photograph, the turn control function sets the participation user whose turn is next as a new turn-come user.

The friend suggestion function includes a function for introducing and suggesting a use to be registered in the friend list (hereinafter, referred to as a “suggestion function”). Although described in detail below, the suggestion function determines another user to be suggested to the registered user. The friend list management function includes a function for registering, in the friend list, the user selected by the registered user from among the suggested users. The search function searches the user information stored in the server device 10 to display one or more pieces of the retrieved user information on the user terminal in a predetermined order. The user information includes the ID of the registered user, the ID of the group to which the registered user belongs, the user ID of the partner with whom the registered user has shared an image in the past, the ID on the SNS, and the like.

The mail integration function is for causing the user to have a chat with a desired user without considering whether the user to be invited is a registered user. When receiving a request of the start of the SNS service from the user terminal, the server device 10 determines the communication system to the destination on the SNS service. Specifically, the server device 10 determines the most appropriate communication system in the registration information stored in the memory in the server device 10 according to the information about the priority of the communication system so as to convert the message transmitted from the user terminal into a mode of the communication system, for example, an email mode and transmit the message to the destination.

A chat mode is basically selected as the communication system applied for the communication with the destination when the destination is a registered user. On the other hand, when the destination is an unregistered user, a mode is selected according to the information about the unregistered user registered in the memory. The detail will be described below. According to such an aspect, the user can have a chat with the destination regardless of whether the destination is an unregistered user.

When using the photograph posting service, the user terminal first accesses the server device 10 to download and install the application. Then, the user terminal uploads the contact information registered in the terminal according to the request from the server device 10. After that, when using the photograph posting service, the user terminal can use the photograph posting service by starting the application and registering a friend registered in the friend list or the user retrieved by the search function as a participation user.

The user of the user terminal can post a photograph in the photograph posting service regardless of whether it is the user's turn and can also have a communication with the participation users by putting a comment or pressing an evaluation button on the posted photograph. Furthermore, the user can remind the turn-come user to post a photograph. This enhances smooth photograph postings in turn.

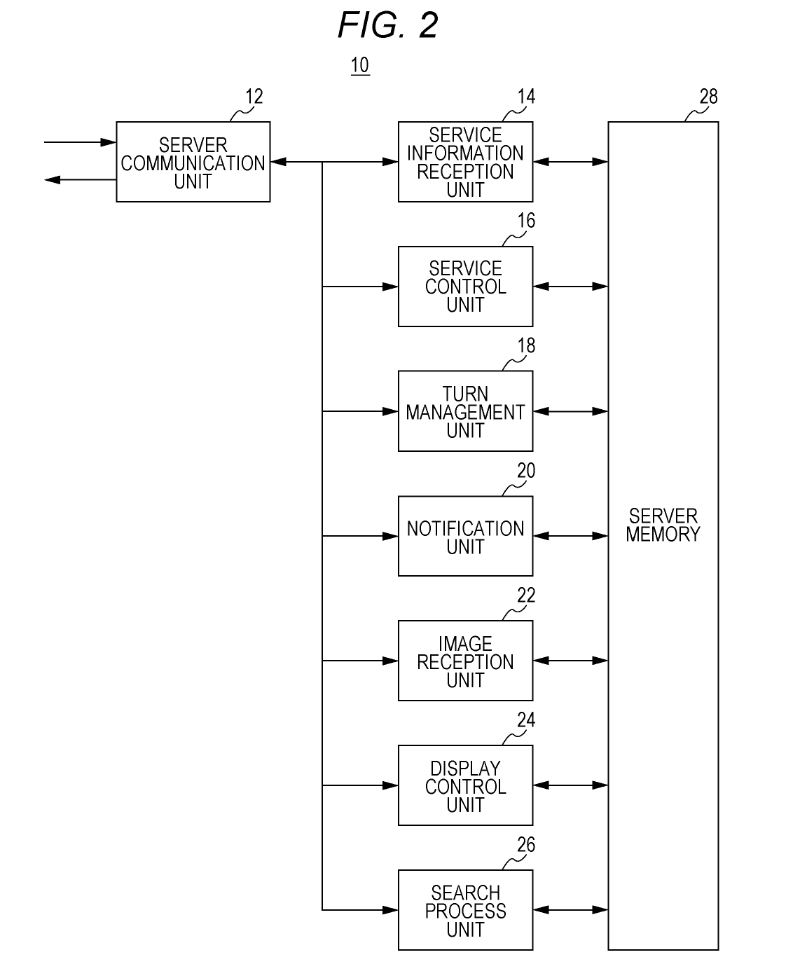

FIG. 2 illustrates an exemplary configuration of the server device 10 in the SNS system 100 in FIG. 1. The server device 10 includes a server communication unit 12, a service information reception unit 14, a service control unit 16, a turn management unit 18, a notification unit 20, an image reception unit 22, a display control unit 24, a search process unit 26 and, a server memory 28.

The server communication unit 12 receives a signal from a user terminal and performs a predetermined demodulation process in order to transmit the demodulated signal to the service information reception unit 14, the service control unit 16, the turn management unit 18, the notification unit 20, the image reception unit 22, the display control unit 24, and the search process unit 26.

The server communication unit 12 transmits predetermined data to the user terminal in a predetermined communication system. The transmission of predetermined data includes, for example, a notification of a reminder message to the turn-come user with the notification unit 20, a distribution of the posted photograph received with the image reception unit 22 to the other participation user. The server communication unit 12 transmits the friend list or suggestion list stored in the server memory 28 to the user terminal of the user that is linked to the list at a predetermined timing.

Note that the modulation and demodulation process in the server communication unit 12 can be a conventionally used modulation and demodulation technique. It should be understood by a person with an ordinary skill in the art that the present invention can also be applied to such an aspect.

The service information reception unit 14 manages the information uploaded by the user that has executed the photograph posting application in the server memory 28. The service information reception unit 14 receives a request for starting the photograph posting service and the information about one or more users that are to participate in the photograph posting service from the terminal of the user through a communication line.

The request for starting the photograph posting service includes a request for generating a new room for collecting the participation users that are to post photographs (hereinafter, referred to as a new room generation request) or a request for resuming a room generated in the past (hereinafter, referred to as a resumption request). The new room generation request includes the name of the room and the theme of the photographs to be posted. The information about the user includes the user identification information, the user name, the avatar image information, and the comment input by the user. The information about the user can be referenced and used, for example, in the turn management unit 18 or the display control unit 24.

The service information reception unit 14 sends a participation request to one or more users that are to participate in the photograph posting service through the server communication unit 12, and receives the user that has responded to the participation request that the user is to participate as a participation user. The service information reception unit 14 manages the information about the participation user and the name of the room in which the participation user has participated in the server memory 28 with linking them to each other.

The server memory 28 may manage the information about the photograph posting application provided in the SNS system 100 in addition to the information about the user. The information about the photograph posting application can be the execution history of the photograph posting application, the information about the room generated in the past, or the photograph posted in the past.

The service control unit 16 reads the photograph posting application that the user is to download from the server memory 28, imports the contact information transmitted from the user terminal into the server memory 28, and access the information for determining the communication system in the server memory 28. The service control unit 16 causes the user terminal to download the application according to the request from the user terminal. After causing the user terminal to download the application, the service control unit 16 sends an inquiry to the user terminal about whether to import the contact information stored in the user terminal into the server device 10. If the import is allowed, the contact information is transmitted from the user terminal. Then, the service control unit 16 writes the information to the server memory 28.

The service control unit 16 includes the friend suggestion function, and determines another user to be suggested to the registered user as a candidate for a friend using a predetermined condition set by the presence or absence of the registration of the candidate user in the SNS in order to register the user in the suggestion list in the server memory 28. The predetermined condition set by the presence or absence of the registration of the candidate user in the SNS varies depending on whether the user to be suggested is a registered user or an unregistered user. The condition is for estimating the familiarity with the suggested user.

The service control unit 16 further includes the friend list management function, and registers, in the friend list in the server memory 28, the user received through the server communication unit 12 and selected by the registered user terminal from among the users registered as candidates for a friend in the suggestion list. The friend list is managed for each of the registered users in the server memory 28.

The service control unit 16 includes a friend search function, and searches the users included in the suggestion list of the registered user stored in the server memory 28 for one or more users to be displayed when the user terminal of the registered user does not send a request. The user that has been retrieved at that time is displayed as a candidate for a friend on the user terminal.

When a plurality of users has been retrieved, the order of display is determined according to a predetermined algorithm in order to display the users on the screen of the user terminal. In other words, a list of the candidates for a friend is displayed as “people who may be your friend” on the user terminal. The search and the display can be performed at the start of the SNS application or at constant intervals after the start. This can give a chance to make more friends to the user.

The service control unit 16 receives a real name search request from the user terminal of the registered user through the server communication unit 12 to obtain the searched real name. Then, the service control unit 16 searches all the user information stored in the server memory 28 for the real name. A conventional search technique such as a forward match search or a partial match search can be used for the search.

When a plurality of users has been retrieved, the order of display is determined according to a predetermined algorithm determined according to the familiarity with the registered user in order to transmit the retrieved users through the server communication unit 12 and display the users on the screen of the user terminal. The suggestion list is managed for each of the registered users in the server memory 28.

When determining the communication system with the destination, the service control unit 16 can select a communication system from among one or more communication systems associated with the destination and registered in the server memory 28 according to the information indicating the order of priority of the communication system to be applied.

The turn management unit 18 manages each participation user's turn to upload an image. Specifically, after the service information reception unit 14 has received a new room generation request, the turn management unit 18 registers and manages the name of the new room and the participation user in the server memory 28 with linking them to each other.

When the service information reception unit 14 has received the new room generation request, the turn management unit 18 ranks the registered participation users and makes each registered participation user take their turn according to such ranking. The ranking can be in order of registration, in alphabetical order of the registered participation user names, or in an arbitrarily determined order. The turn management unit 18 manages the participation user that is the turn-come user using the server memory 28.

Subsequently, the turn management unit 18 starts the photograph posting service with the first set participation user determined as the turn-come user. When the image reception unit 22 receives an image that has been uploaded by the turn-come user, the turn management unit 18 determines the participation user whose turn is next as a new turn-come user and sets the participation user in the server memory 28.

Note that the turn management unit 18 accesses the server memory 28 to resume the selected room when the service information reception unit 14 has received a resumption request.

After the service information reception unit 14 has received a start request, the notification unit 20 notifies the terminal of the turn-come user whose turn has come of the fact that the user's turn has come. The turn is managed with the turn management unit 18. The notification can have any form capable of notifying the turn-come user of the fact that the user's turn has come, for example, a form in which a message to facilitate uploading of an image or a message indicating that the user's turn has come is displayed as a pop-up image on the user terminal, a form in which a message to facilitate uploading of an image or a message indicating that the user's turn has come is displayed on the message field on the service screen when the application is started, a form in which sound effects are made, a form in which a vibrator is activated, or a combination thereof. This can efficiently notify the turn-come user of the fact that the user's turn has come.

When receiving a reminder request from the participation user whose terminal displays a reminder button, the notification unit 20 further notifies the terminal of the turn-come user of the reception of the reminder request. The notification can be sent together with predetermined sound effects, image or the like, and can include the instruction information to vibrate the terminal. This can more efficiently facilitate the photograph posting of the turn-come user.

The image reception unit 22 receives the image uploaded from the terminal of the participation user to store the image in the server memory 28. At that time, the display control unit 24 displays the image received in the image reception unit 22 on the screen in the terminal of the participation user. The display control unit 24 further displays the reminder button to remind the turn-come user to upload an image on the terminals of the participation users other than the turn-come user.

The search process unit 26 receives a search word from the participation user to perform an image search process. At that time, the display control unit 24 displays one or more of the images retrieved with the search process unit 26 on the terminal of the participation user. The image reception unit 22 receives a retrieved image selected by the participation user to store the image in the server memory 28.

Note that the search process can be performed in the user terminal. In such a case, the server device 10 can receive the retrieved image that the user terminal has retrieved and selected as the photograph to be posted.

Searching Web pages on the network can obtain a photograph to be posted in the search process. When the user has input a search word, the Web pages are searched using the search word. Then, the images of the search results are displayed as a list. The user selects the photograph that the user likes from the list. Pressing the posting button downloads the photograph from the Web page. Furthermore, automatically uploading the photograph to the server posts the photograph.

Such an aspect can easily find a photograph from a Web page and post the photograph even when the user does not have a photograph to upload or when the user is not in an environment where the user can take a good photograph. This can smoothly maintain exchanging the posted photographs without a pause and thus can stimulate the room.

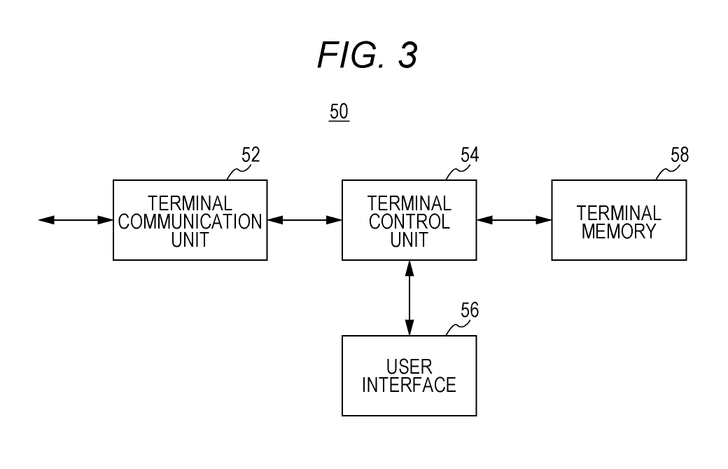

Next, the configuration on the user terminal side will be described with reference to FIG. 3. FIG. 3 illustrates exemplary configuration of the mobile terminal 50 or the PC terminal 70 in FIG. 1. For convenience of description, the configuration of the mobile terminal 50 will be described hereinafter. However, the PC terminal 70 has the same configuration.

The mobile terminal 50 includes a terminal communication unit 52, a terminal control unit 54, a user interface 56, and a terminal memory 58. The terminal communication unit 52 receives the application downloaded from the server device 10 or various types of information transmitted from the server device 10. The terminal communication unit 52 transmits the instruction input by the user through the user interface 56 to the server device 10.

The terminal control unit 54 receives the instruction from the user through the user interface 56 to perform, for example, an application installation control, a new room opening process for starting the photograph posting service, a process for selecting the participation user, a process for uploading a photograph to be posted, or an API control of a social game, with accessing the terminal memory 58.

The user interface 56 displays the photograph posted by the other participation users using the photograph posting service or the information about the photograph posting service. The user interface 56 includes a display device with a sensing function for sensing a tap operation by the user, an input interface configured to receive an input from the user through a keyboard or a touch panel, and an image taking unit such as a camera. The posted photograph can be an image taken using the image taking unit or an image stored in the terminal memory 58.

The terminal memory 58 is used for storing an application program in an application service without using a Web browser. However, the terminal memory 58 can also be used, for example, as a cache memory or for temporarily storing image data in a browser service provided through a Web browser.

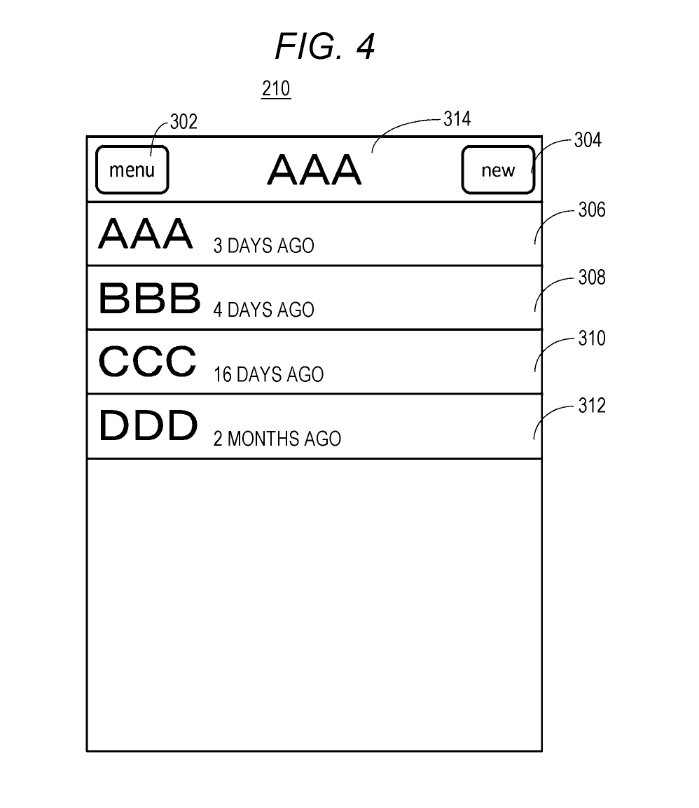

Hereinafter, the general operation of the present invention will be described with reference to first to fifth exemplary screen displays in the user terminal illustrated in FIGS. 4 to 8. Note that the same displays on the exemplary screen displays will be described at only their first appearance. The descriptions will be omitted while the same reference signs are put on the same displays at the second and subsequent appearances.

FIG. 4 illustrates a first exemplary screen display 210 of the user terminal in FIG. 1. The first exemplary screen display 210 includes a menu button 302, a room generating button 304, room display fields 306, 308, 310, and 312, and a room name display field 314.

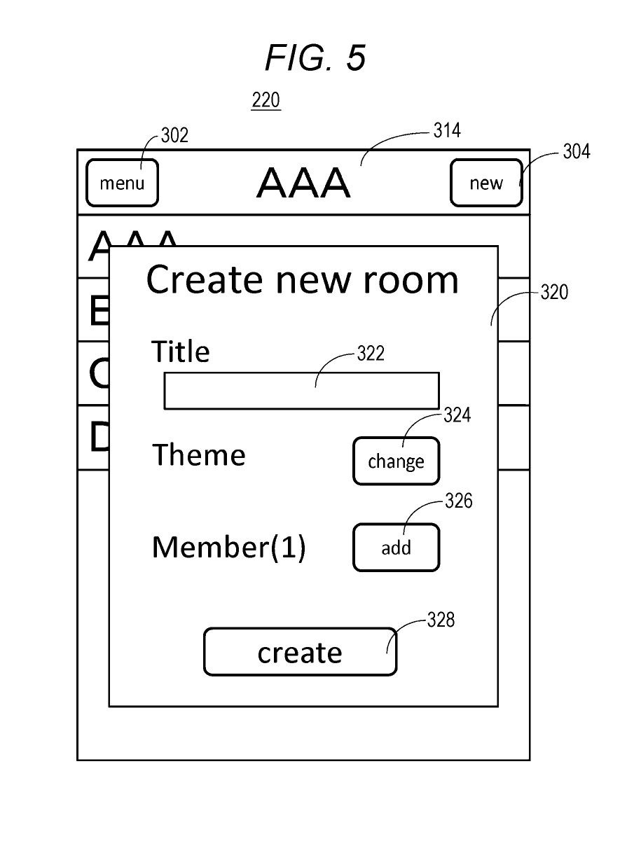

When the user starts the photograph posting application on the mobile terminal, a screen illustrated as the first exemplary screen display 210 is displayed. A list of the rooms that the user has generated in the past or in which the user has become the participation user is displayed on the room display fields 306, 308, 310, and 312 in the first exemplary screen display 210. The name of the room that the user currently selects is displayed on the room name display field 314. When the user taps the room generating button 304, a room generation screen illustrated in FIG. 5 is displayed.

FIG. 5 illustrates a second exemplary screen display 220 of the user terminal in FIG. 1. The second exemplary screen display 220 includes a room generation screen 320, a title entry field 322, a theme setting button 324, a participation user adding button 326, and a room generating button 328.

The user can input the name of the room by tapping the title entry field 322 on the second exemplary screen display 220. The user can set the theme to be put on the posted photograph by tapping the theme setting button 324. The user can select (one or more) arbitral friends from the user's friend list by tapping the participation user adding button 326. The setting described above opens a room. Note that the user found in an ID search can be selected as the participation user.

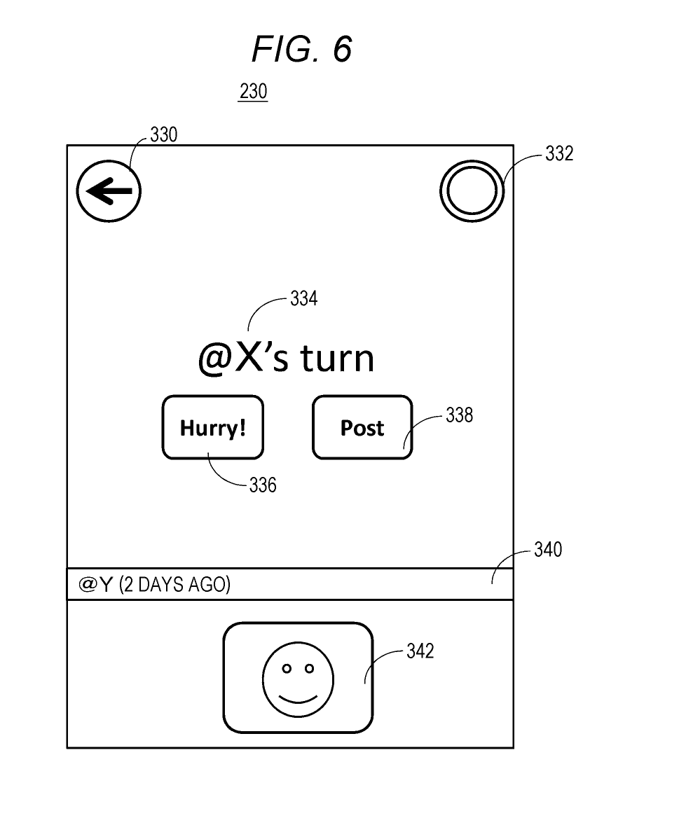

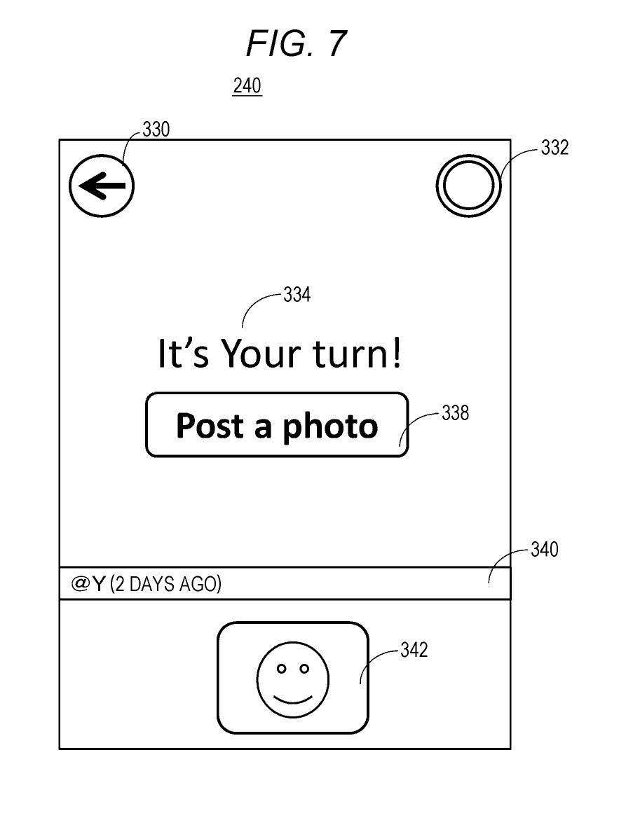

On the other hands, when the user selects one of the rooms on the first exemplary screen display 210, a screen illustrated in FIG. 6 or FIG. 7 is displayed.

FIG. 6 illustrates a third exemplary screen display 230 of the user terminal in FIG. 1. The third exemplary screen display 230 is displayed on the user terminal of the participation users other than the turn-come user. The third exemplary screen display 230 includes a return button 330, a setting button 332, a message field 334, a reminder button 336, a posting button 338, a poster name display field 340, and a posted image display field 342.

The return button 330 is for returning the screen to the last screen with a tap by the user. The setting button 332 is for setting the details about the photograph posting service. The message field 334 is a field on which a message to the user is displayed. The reminder button 336 is for reminding the turn-come user of the photograph posting. The posting button 338 is for posting a photograph. The user can post a photograph at an appropriate time by tapping the posting button even when it is not the user's turn. The poster name display field 340 is a field, for example, on which the name of the user that has posted a photograph in the past is displayed. The posted image display field 342 is a field on which the photograph posted in the past is displayed.

As illustrated as the third exemplary screen display 230, the name of the user whose turn has come is displayed on the message field 334 on the room screen of the user terminal of the user whose turn it is not. The reminder button 336 and the posting button 338 are also displayed. At that time, the user can remind the user that is the turn-come user to post a photograph by tapping the reminder button 336 and causing a message that is a reminder of posting, such as “Hurry!”, to be displayed.

The message “Hurry!” is displayed as a push notification on the mobile terminal of the user to whom the message “Hurry!” has been sent. This can noticeably inform the user whose turn to post a photograph has come of the fact that it is the user's turn. As a result, making the user aware of that fact that it is the user's turn to post a photograph can facilitate the photograph posting. This can stimulate the room.

FIG. 7 illustrates a fourth exemplary screen display 240 of the user terminal in FIG. 1. The fourth exemplary screen display 240 is displayed on the user terminal of the turn-come user. As illustrated in the drawing, the fact that it is the user's turn is displayed on the message field 334. Differently from the third exemplary screen display 230, only the posting button 338 is displayed without the reminder button 336. The turn-come user can select a photograph to post by tapping the posting button 338. This completes the turn such that the server device 10 sets a new turn-come user.

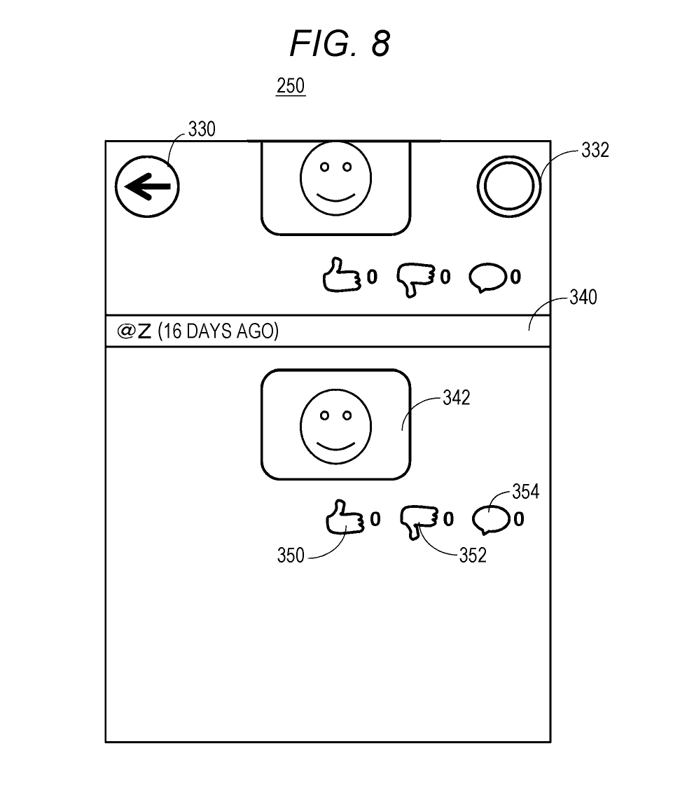

FIG. 8 illustrates a fifth exemplary screen display 250 of the user terminal in FIG. 1. The fifth exemplary screen display 250 is a screen on which the photograph posted in the past in the room is displayed. The fifth exemplary screen display 250 includes a like button 350, a dislike button 352, and a comment button 354. The like button 350 and the dislike button 352 are for a simple indication of intention for the posted photograph. The comment button 354 is for inputting a comment on the posted photograph after a tap of the comment button. The buttons stimulate the communication about the posted photograph.

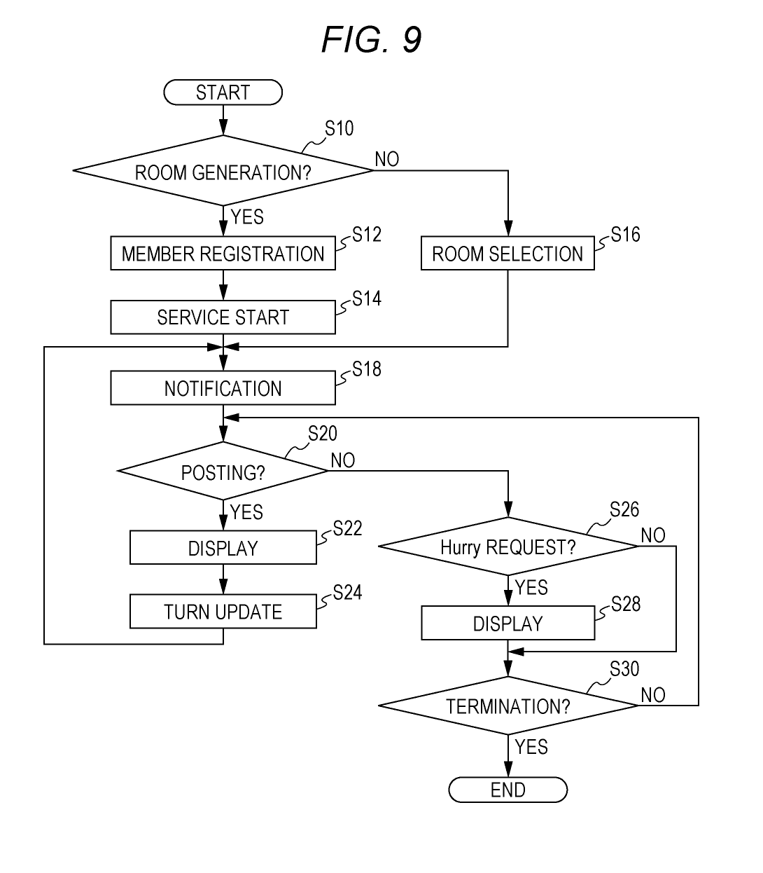

Next, an exemplary operation will be described. FIG. 9 illustrates the flowchart describing an exemplary process of the server device 10 in FIG. 1. The fact that the user has started the application for executing the photograph posting service can trigger the start of the process in the flowchart.

After receiving the start request of the photograph posting application from the user terminal, the server device 10 determines whether the start request includes a new room generation request or the start request is a resumption request of the room generated in the past (step S10). When the start request is a new room generation request (Yes in step S10), the server device 10 receives the registration of the user that is to participate from the user terminal (step S12), and starts the photograph posting service (step S14). On the other hand, when the start request is a resumption request (No in step S10), the server device 10 receives the notification of the selected room (step S16) and starts the room.

Subsequently, the server device 10 notifies the turn-come user of the fact that the user's turn has come (step S18). When receiving the photograph posted by the turn-come user (Yes in step S20), the server device 10 displays the posted photograph on the screen in the user terminal of the participation user (step S22). Furthermore, the server device 10 updates the turn to set the user whose turn is next as a new turn-come user (step S24). Then, the process goes back to step S18.

When the server device 10 has not received the photograph posted by the turn-come user (No in step S20), the procedures in steps S26 to S30 are repeated. When the participation user other than the turn-come user has sent a reminder request of the photograph posting (Yes in step S26), the reception of the reminder request is displayed on the screen in the user terminal of the turn-come user in step S26. Then, the server device 10 determines the termination and the process goes back to step S20. In the termination determination, the server device 10 determines whether the room can be maintained, for example, when the room has been deleted according to the participation user's instruction. When determining that the room cannot be maintained, the server device 10 determines the termination (Yes in step S30), and the process is terminated. The room can be closed after a predetermined time set by the user has elapsed.

Although described above based on the embodiments, the present invention is not limited the embodiments, and can be implemented with an aspect to be described below.

For example, when the turn-come user cannot post a photograph for some reason, notifying the server device 10 of a “pass request” for skipping the turn-come user's turn once causes the turn management unit 18 in the server device 10 to deem that the posting has been done. Then, the participation user whose turn is next can be set as a new turn-come user. According to such an aspect, the participation user can smoothly take the turns. This can prevent the communication with the photograph posting from stagnating.

The screen displayed just after the start of the application can be different between the turn-come user and the user other than the turn-come user. For example, the room list screen in FIG. 4 is displayed when the user other than the turn-come user has started the application while the image posting screen is displayed when the turn-come user has started the application. The image posting screen can be a screen for taking an image with the camera in the user terminal, a screen for selecting the image to post from the image list that the user owns, or a screen for searching the Web pages for an image to post. In other words, when the turn-come user starts the application, a screen for directly posting an image is displayed. Thus, the turn-come user can easily post an image without a complicated operation.

The service control unit 16 can count the number of taps of the like button or the dislike button by the participation users. In such a case, the service control unit 16 ranks the photographs with tallying the count for a predetermined period of time and can give an instruction to the display control unit 24 such that the photograph with more taps of the like button is displayed more highly on the list. Furthermore, the service control unit 16 can control the photograph such that more users can see the photograph after sending an inquiry to the user that has posted the photograph about whether to give the photograph to the public. Furthermore, the service control unit 16 can delete the photograph with many taps of the dislike button. Such an aspect can easily conduct a photograph competition. This motivates the users to post a photograph, and thus can stimulate the communication.

The service control unit 16 can count the number of taps of the reminder button. When the number of taps of the reminder button for a given period of time exceeds a predetermined number, the service control unit 16 can change the effect for the notification to the turn-come user. The effect can be changed depending on the number, for example, such that the text size is increased, such that sound effects are made with the text display, such that the volume of the sound effects is turned up, or such that a vibrator is activated. Such an aspect can efficiently remind the users to post a photograph.

When a user has posted a photograph, the turn management unit 18 can give a point to the user that has posted the photograph depending on the time required to post the photograph since the last posting. Such an aspect can give the users an incentive to post a photograph soon, and thus can motivate the users to post a photograph. The turn management unit 18 can change the order of posting such that the second turn starts from the user that has posted a photograph in the shortest time since the previous posting. According to such an aspect, the users can smoothly take the turns.

The present invention has been described above based on the embodiments. The present invention is not limited to the embodiments and the contents of each embodiment described above. The present invention can variously be changed and implemented within the gist of the present invention. It should be understood by a person with an ordinary skill in the art that the embodiments have been described above as examples, and thus the components and the procedures in the process can variously be combined and changed. Such exemplary variations are included in the scope of the invention.

What is claimed is:

1. A server device comprising:
a service information reception unit configured to receive a start request of a predetermined social networking service (SNS) from a terminal of a user, and information about one or more participation users that are to participate in the SNS through a communication line;
a turn management unit configured to manage each participation user's turn to upload an image;
a notification unit configured to notify a terminal of a turn-come user whose turn managed with the turn management unit has come of a fact that the turn-come user's turn has come after the service information reception unit has received the start request;
an image reception unit configured to receive an image uploaded from a terminal of a participation user and store the image in a memory; and
a display control unit configured to display the image received with the image reception unit on a screen of the terminal of the participation user,
wherein the turn management unit sets a participation user whose turn is next as a new turn-come user when the image reception unit has received the image uploaded by the turn-come user,
the display control unit displays a reminder button for reminding a turn-come user to upload an image on a terminal of a participation user other than the turn-come user, and
the notification unit notifies the terminal of the turn-come user of reception of a reminder request when receiving the reminder request from the participation user whose terminal displays a reminder button.

2. The server device according to claim 1, further comprising:
a search process unit configured to perform a search process for an image after receiving a search word from the participation user,
wherein the display control unit displays one or more images retrieved in the search with the search process unit on the terminal of the participation user, and
the image reception unit receives a retrieved image that the participation user has selected from among the retrieved images.

3. A server device comprising:
a service information reception unit configured to receive a start request of a predetermined social networking service (SNS) from a terminal of a user, and information about one or more participation users that are to participate in the SNS through a communication line;
a turn management unit configured to manage each participation user's turn to upload an image;
a notification unit configured to notify a terminal of a turn-come user whose turn managed with the turn management unit has come of a fact that the turn-come user's turn has come after the service information reception unit has received the start request;
an image reception unit configured to receive an image uploaded from a terminal of a participation user and store the image in a memory;
a display control unit configured to display the image received with the image reception unit on a screen of the terminal of the participation user; and
a search process unit configured to perform a search process for an image after receiving a search word from the participation user,
wherein the turn management unit sets a participation user whose turn is next as a new turn-come user when the image reception unit has received the image uploaded by the turn-come user,
the display control unit displays one or more images retrieved in the search with the search process unit on the terminal of the participation user, and
the image reception unit received a retrieved image that the participation user has selected from among the retrieved images.

4. A non-transitory computer-readable storage medium storing program for causing a computer to execute a process, the process comprising:
receiving a start request of a predetermined social networking service (SNS) from a terminal of a user, and information about one or more participation users that are to participate in the SNS through a communication line;
notifying, after receiving the start request, a terminal of a turn-come user whose turn to upload an image has come of a fact that the turn-come user's turn has come, the turn being set for each participation user;
receiving an image uploaded from a terminal of a participation user and storing the image in a memory;
displaying the image received from the participation user on a screen of the terminal of the participation user;
setting a participation user whose turn is next as a new turn-come user after reception of the image uploaded by the turn-come user;
displaying a reminder button for reminding a turn-come user to upload an image on a terminal of a participation user other than the turn-come user; and
notifying the terminal of the turn-come user of reception of a reminder request when receiving the reminder request from the participation user whose terminal displays a reminder button.
